(19) United States
(12) Patent Application Publication
(10) Pub. No.: US 2026/0050469 A1
(43) Pub. Date: Feb. 19, 2026

(54) STRATEGY FOR INSTRUCTION SCHEDULING OF MULTIPLE WAVES BASED ON INSTRUCTION STATUS

(71) Applicant: Advanced Micro Devices, Inc., Santa Clara, CA (US)

(72) Inventors: JiXin Shan, Shanghai (CN); Qian Zhang, Shanghai (CN); ZhongXiang Luo, Shanghai (CN)

(21) Appl. No.: 18/802,120

(22) Filed: Aug. 13, 2024

(51) Int. Cl. G06F 9/48; G06F 9/54; G06F 15/80

(52) U.S. Cl. CPC G06F 9/4881; G06F 9/544; G06F 15/8053

(57) ABSTRACT

An apparatus and method for efficiently scheduling instructions for a parallel data processing circuit. In various implementations, a computing system includes a parallel data processing circuit with multiple compute circuits, each uses multiple single instruction multiple data (SIMD) circuits. Each compute circuit includes a scheduler for selecting instructions to issue to the SIMD circuits. The scheduler assigns priority levels to wavefronts based on two factors. The first factor includes balancing execution of instructions of a first instruction type across the multiple wavefronts. For example, the scheduler maintains a count of issued instructions of the first type for each wavefront. The second factor includes satisfying urgency of execution of instructions of a second instruction type across the plurality of wavefronts. The scheduler combines the two factors to create priority levels for each of the wavefronts.

### BACKGROUND

### Description of the Relevant Art

The parallelization of tasks is used to increase the throughput of computing systems. To this end, compilers extract parallelized tasks from applications to execute in parallel on the system hardware. To increase parallel execution on the hardware, many different types of computing systems include vector processing circuits or single-instruction, multiple-data (SIMD) circuits. Vector processing circuits, or SIMD circuits, include multiple parallel lanes of execution. Tasks can be executed in parallel on these types of parallel data processing circuits to increase the throughput of the computing system. The memory stores at least the instructions (or translated commands) of a parallel data application. The instructions are placed in kernels, each corresponding to a function call in the parallel data application. These types of micro-architectures provides higher instruction throughput for parallel data applications than a general-purpose micro-architecture. Tasks that benefit from the SIMD micro-architecture are used in a variety of applications in a variety of fields such as medicine, entertainment, engineering, social media, science, finance, and so on.

The throughput of the SIMD micro-architecture is highly dependent on the instructions filling the pipeline stages of the parallel execution lanes of the SIMD circuits. When a pipeline stage does not receive an instruction to process, the pipeline stage has a stall, or a “bubble,” inserted in it and no useful work is performed for that pipeline stage. For example, an arithmetic instruction can't begin execution until its source operands are ready and fetched. The latency of a previous in-order memory access instruction can insert stalls in the pipeline, which reduces performance.

In view of the above, efficient methods and apparatuses for efficiently scheduling instructions for a parallel data processing circuit are desired.

### BRIEF DESCRIPTION OF THE DRAWINGS

FIG. 1 is a generalized diagram of a computing system that efficiently schedules instructions for a parallel data processing circuit.

FIG. 2 is a generalized diagram of an apparatus that efficiently schedules instructions for a parallel data processing circuit.

FIG. 3 is a generalized diagram of wave priority setting for efficiently scheduling arithmetic instructions for a parallel data processing circuit.

FIG. 4 is a generalized diagram of wave priority setting for efficiently scheduling memory access instructions for a parallel data processing circuit.

FIG. 5 is a generalized diagram of wave priority setting for efficiently scheduling instructions of different types for a parallel data processing circuit.

FIG. 6 is a generalized diagram of a method for efficiently scheduling instructions of different types for a parallel data processing circuit.

FIG. 7 is a generalized diagram of a method for efficiently scheduling instructions of different types for a parallel data processing circuit.

FIG. 8 is a generalized diagram of a method for efficiently scheduling instructions of different types for a parallel data processing circuit.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for efficiently scheduling instructions for a parallel data processing circuit are disclosed. In various implementations, a computing system includes a parallel data processing circuit that includes one or more compute circuits, each with multiple single instruction multiple data (SIMD) circuits. As used herein, a “SIMD” circuit can also be referred to as a “vector processing circuit.” Each of the SIMD circuits includes circuitry of multiple parallel lanes of execution, and using the multiple parallel lanes, executes a wavefront of multiple wavefronts of a workgroup. Each compute circuit includes a scheduler for selecting instructions to issue to the SIMD circuits. Rather than assigning priority levels to the wavefronts based on only ages of the wavefronts, the scheduler assigns priority levels to wavefronts based on at least two other factors. The first factor includes balancing an execution rate of instructions of a first instruction type across the multiple wavefronts. In an implementation, the first instruction type is a vector arithmetic type of instruction, and the first factor is based at least in part on a count of issued vector arithmetic instructions for each wavefront. In another implementation, the first factor is based at least in part on a count of completed vector arithmetic instructions for each wavefront.

In some implementations, the second factor includes satisfying urgency of execution of instructions of a second instruction type across the multiple wavefronts. In an implementation, the second instruction type is a vector memory access type of instruction, and the second factor is based on ages of the vector memory access instructions. Vector memory access instructions with higher ages (older ages) provide higher priority levels to corresponding wavefronts than vector memory instructions with lower ages (younger ages). Therefore, in an implementation, wavefronts with the oldest memory access instructions have higher priority levels than priority levels of wavefronts with younger vector memory access instructions. In some implementations, the positions of vector memory access instructions in instruction buffers correspond to ages of the vector memory access instructions. In an implementation, the instruction buffers use a first-in-first-out (FIFO) data storage arrangement such that the position of an instruction in the instruction buffer indicates the age of the instruction. In such an implementation, the lower the position (the lower the entry number) of the memory access instruction in a corresponding instruction buffer, the older is the memory access instruction corresponding to the entry and the higher the priority level for the corresponding wavefront. The position is indicated by the actual entry in the instruction buffers. Alternatively, the position is indicated by updated pointer values indicating the first allocated entry (oldest entry) and the last allocated entry (youngest entry) of instruction buffers.

In other implementations, the ages of the oldest memory access instructions stored in the instruction buffers are indicated by an age field in the entries of the instruction buffers. Other indications of the ages of the oldest memory access instructions stored in the instruction buffers are possible and contemplated in other implementations. The scheduler combines the two factors to create priority levels for each of the wavefronts. By not generating the priority levels based only on ages of wavefronts, the scheduler balances the workload that includes the vector arithmetic instructions and improves the capability of hiding the latency of the vector memory instructions for each of the wavefronts executing on the SIMD circuits. Thus, efficiency of instruction execution increases and performance increases.

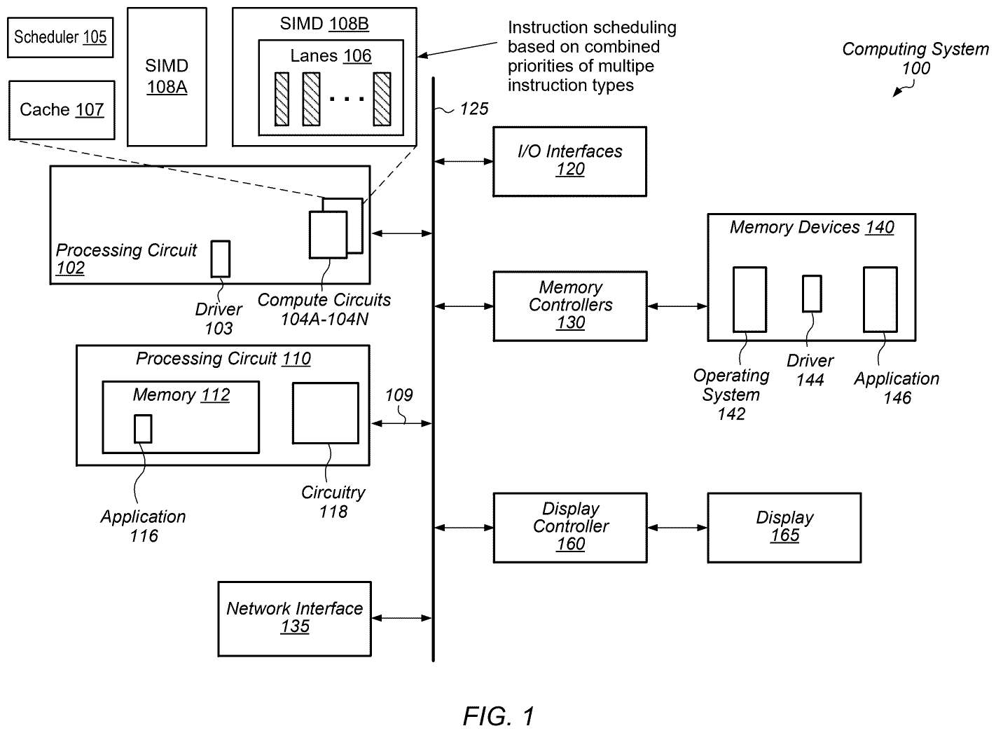

The instructions of the wavefronts are stored in a corresponding one of multiple instruction buffers. Each instruction buffer is assigned to one of the multiple SIMD circuits. Based on the priority levels, the scheduler within the compute circuit selects multiple instructions from the multiple instruction buffers to issue to the SIMD circuits. A command processing circuit issues work at the larger granularity of a workgroup that includes multiple wavefronts. The command processing circuit assigns each workgroup to a corresponding compute circuit. One or more of the command processing circuit and the compute circuit divides a workgroup into multiple, individual wavefronts. The multiple wavefronts are assigned to the multiple SIMD circuits of the compute circuit. The scheduler then selects instructions from the instruction buffers to issue to the SIMD circuits based on the priority levels that rely on the above two factors. Further details of these techniques for efficiently processing instructions in hardware parallel execution lanes within a processing circuit are provided in the following description of FIGS. 1-8.

Turning now to FIG. 1, a generalized diagram is shown of a computing system 100 that efficiently processes instructions in hardware parallel execution lanes within a processing circuit. In an implementation, computing system 100 includes at least processing circuits 102 and 110, input/output (I/O) interfaces 120, bus 125, network interface 135, memory controllers 130, memory devices 140, display controller 160, and display 165. In other implementations, computing system 100 includes other components and/or computing system 100 is arranged differently. For example, power management circuitry, and phased locked loops (PLLs) or other clock generating circuitry are not shown for ease of illustration. In various implementations, the components of the computing system 100 are on the same die such as a system-on-a-chip (SOC). In other implementations, the components are individual dies in a system-in-package (SiP) or a multi-chip module (MCM). A variety of computing devices use the computing system 100 such as a desktop computer, a laptop computer, a server computer, a tablet computer, a smartphone, a gaming device, a smartwatch, and so on.

Processing circuits 102 and 110 are representative of any number of processing circuits which are included in computing system 100. In an implementation, processing circuit 110 is a general-purpose central processing unit (CPU). In one implementation, processing circuit 102 is a parallel data processing circuit with a highly parallel data microarchitecture, such as a GPU. The processing circuit 102 can be a discrete device, such as a dedicated GPU (dGPU), or the processing circuit 102 can be integrated (an iGPU) in the same package as another processing circuit. Other parallel data processing circuits that can be included in computing system 100 include digital signal processing circuits (DSPs), field programmable gate arrays (FPGAs), application specific integrated circuits (ASICs), and so forth.

In various implementations, the processing circuit 102 includes multiple, replicated compute circuits 104A-104N, each including similar circuitry and components such as a single instruction multiple data (SIMD) circuits 108A-108B, the cache 107, and hardware resources (not shown). The SIMD circuit 108A includes replicated circuitry of the circuitry of the SIMD circuit 108B. Although two SIMD circuits are shown, in other implementations, another number of SIMD circuits is used based on design requirements. As shown, the SIMD circuit 108B includes multiple, parallel computational lanes 106. Cache 107 can be used as a shared last-level cache in a compute circuit.

In various implementations, the data flow of SIMD circuit 108B is pipelined and the parallel execution lanes 106 operate in lockstep. In various implementations, the circuitry of each of the execution lanes 106 is an instantiated copy of circuitry for arithmetic logic units (ALUs) that perform integer arithmetic, floating-point arithmetic, Boolean logic operations, branch condition comparisons, and so forth. Each of the ALUs within a given row across the execution lanes 106 includes the same circuitry and functionality, and operates on the same instruction, but different data, such as a different data item, associated with a different thread. Pipeline registers are used for storing intermediate results.

A particular combination of the same instruction and a particular data item of multiple data items is referred to as a “work item.” A work item is also referred to as a thread. The multiple work items (or multiple threads) are grouped into thread groups, where a “thread group” is a partition of work executed in an atomic manner. In some implementations, a thread group includes instructions of a function call that operates on multiple data items concurrently. Each data item is processed independently of other data items, but the same sequence of operations of the subroutine is used. As used herein, a “thread group” is also referred to as a “work block” or a “wavefront.”

Tasks performed by execution lanes 106 can be grouped into a “workgroup” that includes multiple thread groups (or multiple wavefronts). Each of the compute circuits 104A-104N processes an assigned workgroup, and each of the SIMD circuits 108A-108B processes an assigned wavefront. The hardware, such as circuitry, of a scheduler (not shown) divides the workgroup into separate thread groups (or separate wavefronts) and assigns the wavefronts to be dispatched to SIMD circuits 108A-108B. In an implementation, such a scheduler is a command processing circuit of a GPU. In various implementations, scheduler 105 receives the wavefronts for one of the compute circuits 104A-104N, and schedules instructions of these wavefronts to be issued to SIMD circuits 108A-108B.

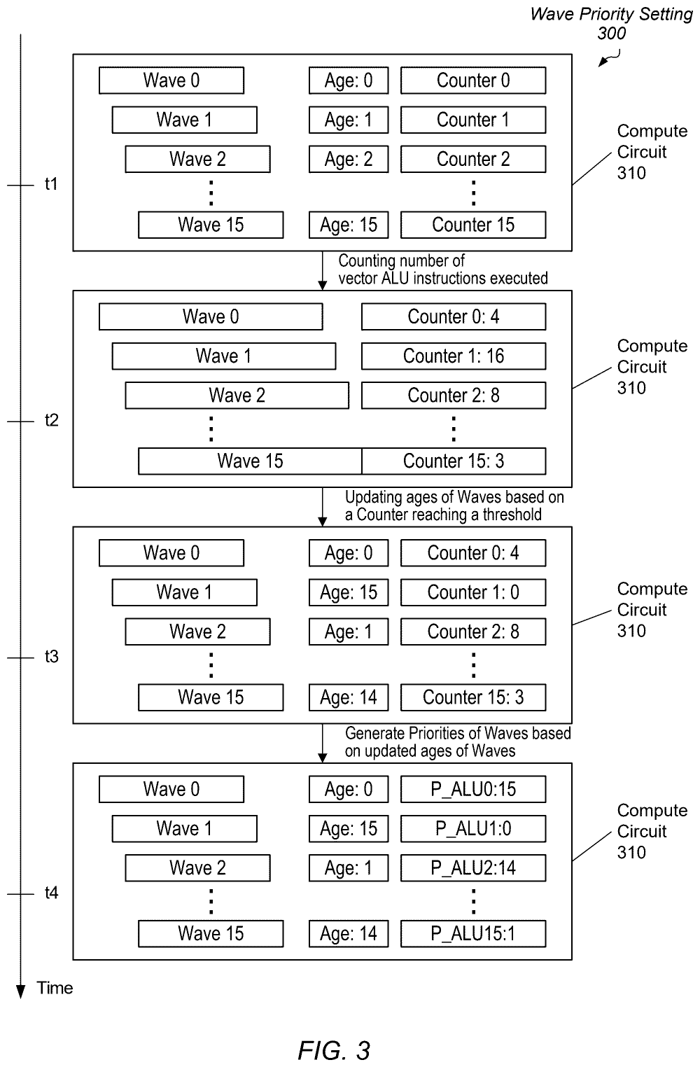

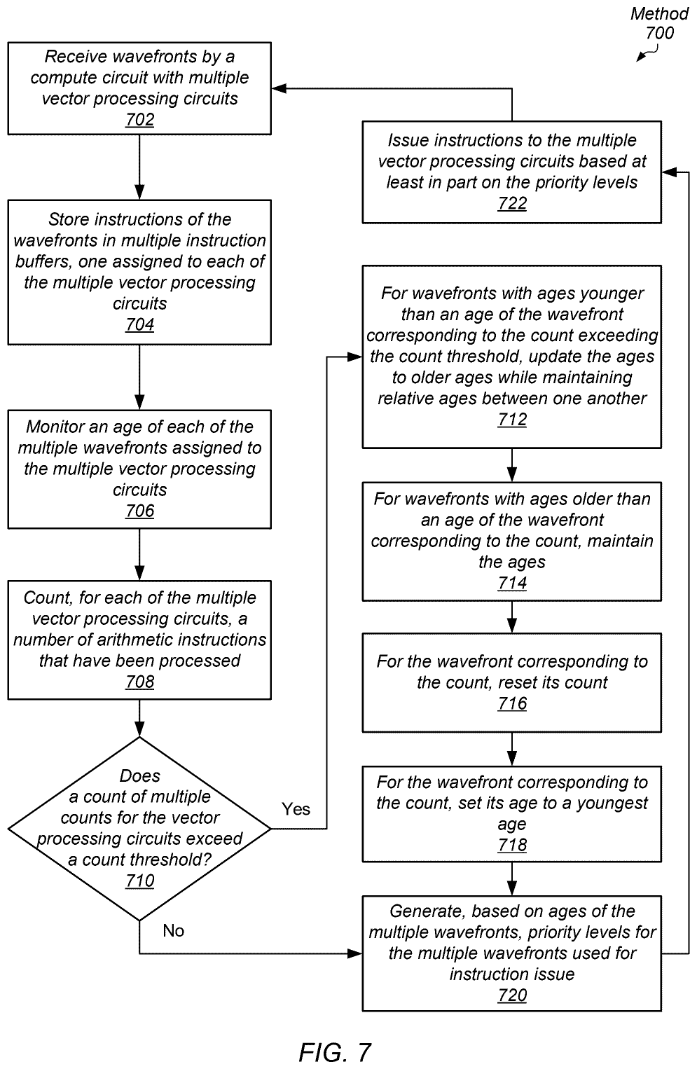

Scheduler 105 generates a first set of priority levels for the multiple wavefronts based at least in part on a number of instructions issued of a first instruction type for each of the multiple wavefronts. In another implementation, scheduler 105 generates the first set of priority levels for the multiple wavefronts based at least in part on a number of instructions completed of the first instruction type for each of the multiple wavefronts In some implementations, the first instruction type is a vector arithmetic type of instruction. The first set of priority levels includes balancing execution of instructions of the first instruction type across the multiple wavefronts. In some implementations, when the first set of priority levels is based on a count of issued vector arithmetic instructions for each wavefront, scheduler 105 reduces the priority level of the wavefront of the multiple wavefronts that reaches a count threshold. In an implementation, scheduler 105 reduces the priority level of this wavefront to a minimum level. In an implementation, wavefronts that are younger than the wavefront that reached the count threshold have their priority levels of the first set of priority levels increased by scheduler 105. Further details of generating the first set of priority levels for the multiple wavefronts are provided in the description of at least the wave priority setting 300 (of FIG. 3) and the method 700 (of FIG. 7).

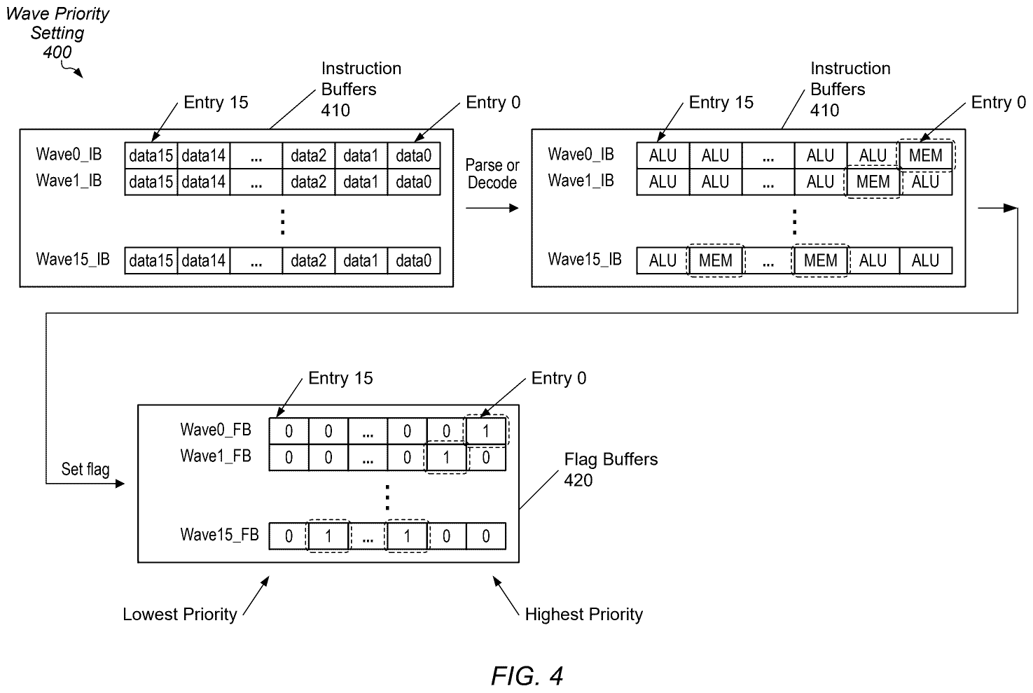

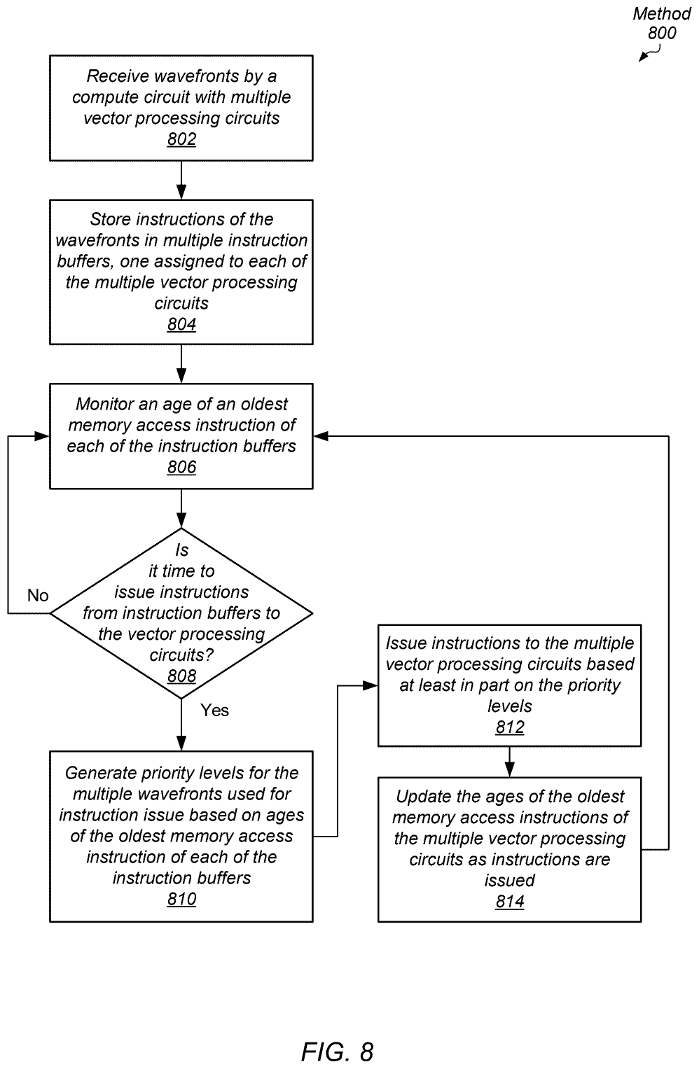

Scheduler 105 generates a second set of priority levels for the multiple wavefronts based on ages of instructions of a second instruction type. In an implementation, the second instruction type is a vector memory access type of instruction. Vector memory access instructions with higher ages (older ages) are issued earlier than vector memory instructions with lower ages (younger ages). Therefore, in an implementation, older vector memory access instructions have higher priority levels than priority levels of younger vector memory access instructions. In some implementations, the positions of vector memory access instructions in instruction buffers correspond to ages of the vector memory access instructions. In an implementation, the instruction buffers use a first-in-first-out (FIFO) data storage arrangement such that the position of an instruction in the instruction buffer indicates the age of the instruction. Therefore, in various implementations, the wavefronts that have the oldest vector memory access instructions have higher priority levels of the second set of priority levels than wavefronts that do not have the oldest vector memory access instructions. Further details are provided in the description of at least the wave priority setting 400 (of FIG. 4) and the method 800 (of FIG. 8). Scheduler 105 generates a third set of priority levels for the multiple wavefronts by combining the first priority levels and the second priority levels.

In some implementations, for each of the wavefronts, scheduler 105 concatenates the corresponding values of the first set of priority levels and the second set of priority levels. In an implementation, scheduler 105 has the corresponding value of the second set of priority levels occupy the most significant bits of the concatenated value. In other implementations, scheduler 105 has the corresponding value of the first set of priority levels occupy the most significant bits of the concatenated value. In yet other implementations, for each of the wavefronts, scheduler 105 generates a weighted sum using the corresponding values of the first set of priority levels and the second set of priority levels. Using other types of combinations for generating the third set of priority levels is possible and contemplated. Scheduler 105 issues instructions from instruction buffers to the SIMD circuits 108A-108B based on the third priority levels.

In some implementations, each of the application 104 stored on the memory devices 140 and its copy (application 116) stored on the memory 112 is a highly parallel data application. The highly parallel data application includes function calls that allow the developer to insert requests in the highly parallel data application for launching wavefronts of a kernel (function call). In various implementations, circuitry 118 of the processing circuit 110 converts (translates) the instructions of the highly parallel data application to commands. In various implementations, the processing circuit 110 stores the commands in a ring buffer in system memory provided by memory devices 140. Processing circuit 102 reads the commands from the ring buffer in the system memory provided by memory devices 140. In an implementation, the ring buffer includes multiple storage locations of the memory devices 140 used to provide a memory mapped input/output (MMIO) first-in-first-out (FIFO) buffer.

In some implementations, application 104 is a highly parallel data application that provides multiple kernels to be executed on the compute circuits 104A-104N. The high parallelism offered by the hardware of the compute circuits 104A-104N is used for real-time data processing. Examples of real-time data processing are rendering multiple pixels, image blending, pixel shading, vertex shading, and geometry shading. In such cases, each of the data items of a wavefront is a pixel of an image. The compute circuits 104A-104N can also be used to execute other threads that require operating simultaneously with a relatively high number of different data elements (or data items). Examples of these threads are threads for scientific, medical, entertainment, finance and encryption/decryption computations.

Memory 112 represents a local hierarchical cache memory subsystem. Memory 112 stores source data, intermediate results data, results data, and copies of data and instructions stored in memory devices 140. Processing circuit 110 is coupled to bus 125 via interface 106. Processing circuit 110 receives, via interface 106, copies of various data and instructions, such as the operating system 142, one or more device drivers such as device driver 144, one or more applications such as application 104, and/or other data and instructions. The processing circuit 110 retrieves a copy of the application 104 from the memory devices 140, and the processing circuit 110 stores this copy as application 116 in memory 112.

In some implementations, computing system 100 utilizes a communication fabric (“fabric”), rather than the bus 125, for transferring requests, responses, and messages between the processing circuits 102 and 110, the I/O interfaces 120, the memory controllers 130, the network interface 135, and the display controller 150. When messages include requests for obtaining targeted data, the circuitry of interfaces within the components of computing system 100 translates target addresses of requested data. In some implementations, the bus 125, or a fabric, includes circuitry for supporting communication, data transmission, network protocols, address formats, interface signals and synchronous/asynchronous clock domain usage for routing data.

Memory controllers 130 are representative of any number and type of memory controllers accessible by processing circuits 102 and 110. While memory controllers 130 are shown as being separate from processing circuits 102 and 110, it should be understood that this merely represents one possible implementation. In other implementations, one of memory controllers 130 is embedded within one or more of processing circuits 102 and 110 or it is located on the same semiconductor die as one or more of processing circuits 102 and 110. Memory controllers 130 are coupled to any number and type of memory devices 140.

Memory devices 140 are representative of any number and type of memory devices. For example, the type of memory in memory devices 140 includes Dynamic Random Access Memory (DRAM), Static Random Access Memory (SRAM), NAND Flash memory, NOR flash memory, Ferroelectric Random Access Memory (FeRAM), or otherwise. Memory devices 140 store at least instructions of an operating system 142, one or more device drivers, and application 104. In some implementations, application 104 is a highly parallel data application such as a video graphics application, a shader application, or other. Copies of these instructions can be stored in a memory or cache device local to processing circuit 110 and/or processing circuit 102.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, and so forth. Network interface 135 receives and sends network messages across a network.

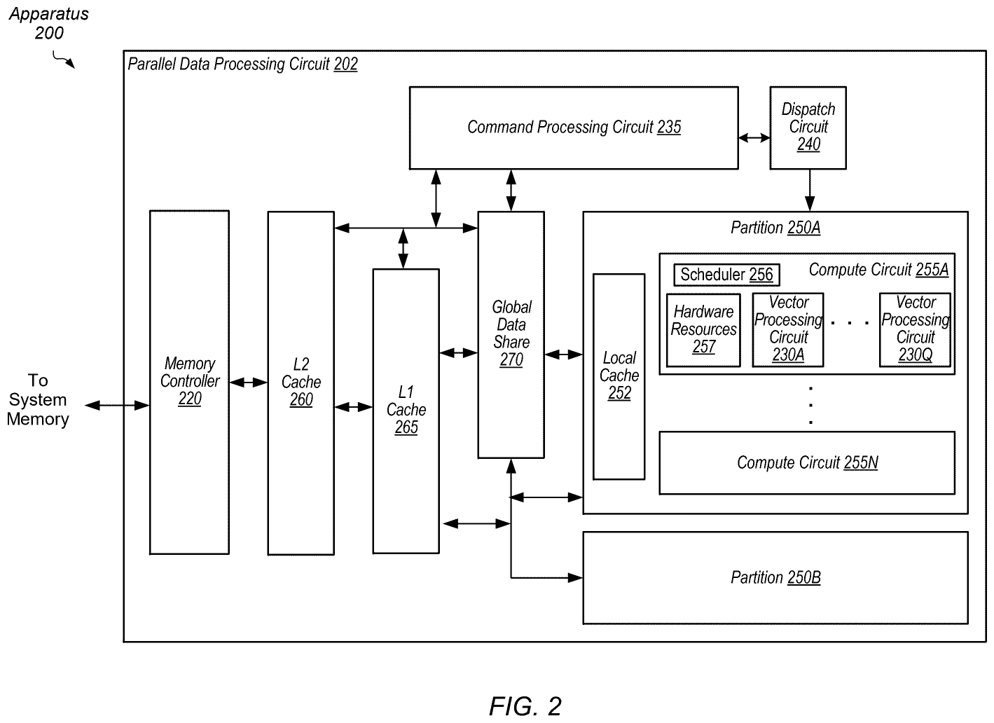

Turning now to FIG. 2, a block diagram is shown of an apparatus 200 that efficiently processes multiplication and accumulate operations for matrices in applications. In one implementation, apparatus 200 includes parallel data processing circuit 202 with an interface to system memory. In an implementation, parallel data processing circuit 202 is a graphics processing unit (GPU). In various implementations, apparatus 200 executes any of various types of highly parallel data applications. As part of executing an application, a host CPU (not shown) launches kernels to be executed by the parallel data processing circuit 202. The command processing circuit 235 receives kernels from the host CPU and determines when dispatch circuit 240 dispatches wavefronts of these kernels to the compute circuits 255A-255N.

Multiple processes of a highly parallel data application provide work to be executed on compute circuits 255A-255N. The parallel data processing circuit 202 includes at least the command processing circuit (or command processor) 235, dispatch circuit 240, compute circuits 255A-255N, memory controller 220, global data share 270, shared level one (L1) cache 362, and level two (L2) cache 260. It should be understood that the components and connections shown for the parallel data processing circuit 202 are merely representative of one type processing circuit and does not preclude the use of other types of processing circuits for implementing the techniques presented herein. The apparatus 200 also includes other components which are not shown to avoid obscuring the figure. In other implementations, the parallel data processing circuit 202 includes other components, omits one or more of the illustrated components, has multiple instances of a component even if only one instance is shown in the apparatus 200, and/or is organized in other suitable manners. Also, each connection shown in apparatus 200 is representative of any number of connections between components. Additionally, other connections can exist between components even if these connections are not explicitly shown in apparatus 200.

In an implementation, the memory controller 220 directly communicates with each of the partitions 250A-250B and includes circuitry for supporting communication protocols and queues for storing requests and responses. Threads within wavefronts executing on compute circuits 255A-255N read data from and write data to the cache 252, vector general-purpose registers, scalar general-purpose registers, and when present, the global data share 270, the shared L1 cache 265, and the L2 cache 260. When present, it is noted that the shared L1 cache 265 can include separate structures for data and instruction caches. It is also noted that global data share 270, shared L1 cache 265, L2 cache 260, memory controller 220, system memory, and cache 252 can collectively be referred to herein as a “cache memory subsystem”.

In various implementations, the circuitry of partition 250B is a replicated instantiation of the circuitry of partition 250A. In some implementations, each of the partitions 250A-250B is a chiplet. As used herein, a “chiplet” is also referred to as an “intellectual property block” (or IP block). However, a “chiplet” is a semiconductor die (or die) fabricated separately from other dies, and then interconnected with these other dies in a single integrated circuit in the MCM. On a single silicon wafer, only multiple chiplets are fabricated as multiple instantiated copies of particular integrated circuitry, rather than fabricated with other functional blocks that do not use an instantiated copy of the particular integrated circuitry. For example, the chiplets are not fabricated on a silicon wafer with various other functional blocks and processors on a larger semiconductor die such as an SoC. A first silicon wafer (or first wafer) is fabricated with multiple instantiated copies of integrated circuitry a first chiplet, and this first wafer is diced using laser cutting techniques to separate the multiple copies of the first chiplet. A second silicon wafer (or second wafer) is fabricated with multiple instantiated copies of integrated circuitry of a second chiplet, and this second wafer is diced using laser cutting techniques to separate the multiple copies of the second chiplet.

In an implementation, cache 252 represents a last level shared cache structure such as a local level-two (L2) cache within partition 250A. Additionally, each of the multiple compute circuits 255A-255N includes vector processing circuits 230A-230Q, each with circuitry of multiple parallel computational lanes of simultaneous execution. These parallel computational lanes operate in lockstep. In various implementations, the data flow within each of the lanes is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration. Each of the ALUs within a given row across the lanes includes the same circuitry and functionality, and operates on the same instruction, but different data, such as a different data item, associated with a different thread.

In addition to the vector processing circuits 230A-230Q, compute circuit 255A also includes the hardware resources 257. The hardware resources 257 include at least an assigned number of vector general-purpose registers (VGPRs) per thread, an assigned number of scalar general-purpose registers (SGPRs) per wavefront, and an assigned data storage space of a local data store per workgroup. Each of compute circuits 255A-255N receives wavefronts from dispatch circuit 240 and stores the received wavefronts in an instruction buffer of a corresponding local dispatch circuit (not shown). A local scheduler 256 within compute circuits 255A-255N schedules instructions of these wavefronts to be dispatched from the local dispatch circuits to the vector processing circuits 230A-230Q. In various implementations, scheduler 256 has the same functionality as scheduler 105 (of FIG. 1). Cache 252 can be the last level shared cache structure of the partition 250A.

Referring to FIG. 3, a generalized diagram is shown of wave priority setting 300 for efficiently scheduling arithmetic instructions for a parallel data processing circuit. In the illustrated implementation, a timeline is shown along with compute circuit 310. Compute circuit 310 includes 16 vector processing circuits (not shown) capable of executing 16 wavefronts (or waves). Compute circuit 310 also includes 16 counters, one for each of the 16 wavefronts. Similarly, compute circuit 310 includes 16 age registers for storing 16 ages, one for each of the 16 wavefronts. Although compute circuit 310 includes 16 vector processing circuits, 16 age registers, and 16 counters, it is noted that in other implementations, another number of vector processing circuits, age registers and counters is used based on design requirements. At point-in-time t1 (or time t1), compute circuit 310 receives the 16 wavefronts, stores them in an instruction buffer (not shown), updates the ages of wavefronts, and begins executing the instructions (or commands) of the wavefronts. The age counters and the counters are initialized to a reset value. In an implementation, the reset value is zero.

As shown, wavefront 0 (or Wave 0) has an age of 0, which indicates the oldest age, and wavefront 15 (or Wave 15) has an age of 15, which indicates the youngest age. Here, the greater the age value, the younger is the corresponding wavefront. Therefore, Wave 6 with an age of 6 is older than Wave 7 with an age of 7. Other values, ranges of ages, and relationships between age values can be used in other implementations. As the vector processing circuits execute the instructions of the wavefronts, each of the counters maintain a count of a number of instructions of a first type executed by a corresponding vector processing circuit for a corresponding wavefront. In some implementations, the compute circuit 310 counts a particular vector arithmetic instruction. In another implementation, the compute circuit 310 counts each type of vector arithmetic instruction. In other implementations, the compute circuit 310 counts each type or a particular type of scalar arithmetic instruction.

In some implementations, a count threshold is stored in a programmable configuration register. Compute circuit 310 compares each of the counters to the count threshold. At time t2, the Counter 1 for Wave 1 reaches 16, which exceeds the count threshold of 15. For wavefronts with ages younger than an age of Wave 1, compute circuit 310 updates the ages to older ages while maintaining relative ages between one another. The updates are shown at time t3. For example, Wave 2 had an age of 2 at time t2, which is younger than Wave 1 that had an age of 1 at time t2. Compute circuit 310 decremented the age of Wave 2 from 2 to 1. The age of 1 for Wave 2 is shown at time t3. Similarly, Wave 15 had an age of 15 at time t2, which is younger than Wave 1 that had an age of 1 at time t2. Compute circuit 310 decremented the age of Wave 15 from 15 to 14. The age of 14 for Wave 14 is shown at time t3.

For wavefronts with ages older than an age of Wave 1 at time t2, compute circuit 310 maintains the ages. For example, Wave 0 had an age of 0 at time t2, which is older than Wave 1 that had an age of 1 at time t2. Compute circuit 310 maintained the age of Wave 0 at 0. The age of 0 for Wave 0 is shown at time t3. For the wavefront corresponding to the count exceeding the count threshold, which is Wave 1, compute circuit 310 resets its count. At time t3, Counter 1 of Wave 1 is reset to the initial value. For Wave 1, compute circuit 310 sets its age to a youngest age. At time t3, the age of Wave 1 is set at 15, which indicates the youngest age. Compute circuit 310 generates, based on ages of the multiple wavefronts, priority levels for the multiple wavefronts used for instruction issue. In an implementation, compute circuit 310 generates priority levels for the wavefronts that have an inverse relationship with the ages of the wavefronts. A youngest wavefront has the lowest priority, whereas the oldest wavefront has the highest priority. At time t4, the priorities are shown for the wavefronts. At time t4, Wave 0 with the oldest age of 0 has the highest priority level of 15. Wave 1 with the youngest age of 15 has the lowest priority level of 0. Wave 2 with the second oldest age of 1 has the second highest priority level of 14. The other wavefronts have their priority levels set in a similar manner.

Turning now to FIG. 4, a generalized diagram is shown of wave priority setting 400 for efficiently scheduling memory access instructions for a parallel data processing circuit. In the illustrated implementation, instruction buffers 410 and flag buffers 420 of a compute circuit of a parallel data processing circuit are updated as instructions are issued to vector processing circuits (not shown). The compute circuit stores instructions of the wavefronts in instruction buffers 410, one assigned to each of the multiple vector processing circuits. In an implementation, the compute circuit includes 16 vector processing circuits (not shown) capable of executing 16 wavefronts (or waves). Instruction buffers 410 have 16 buffers labeled “Wave0_IB” to “Wave15_IB.” Flag buffers 420 have 16 buffers labeled “Wave0_FB” to “Wave15_FB.” Although it is shown that instruction buffers 410 and flag buffers 420 include 16 buffers, it is noted that in other implementations, another number of buffers and another number of vector processing circuits is used based on design requirements.

In various implementations, instruction buffers 410 and flag buffers 420 use flip-flop circuits, registers, or other types of storage elements to store data. In an implementation, instruction buffers 410 and flag buffers 420 are first-in-first-out (FIFO) buffers where “data0 ” is the oldest entry and “data15” is the youngest entry. The size of the data (and corresponding size of the entry) and the number of entries of instruction buffers 410 and flag buffers 420 are based on design requirements. Control circuitry of the compute circuit decodes the instructions of the wavefronts to generate indications of the instruction types. In other implementations, the instructions have already been decoded, and the indications accompany the instructions in the entries of at least instruction buffers 410. As shown, instruction buffers 410 stores at least arithmetic instructions (ALU) and memory access instructions (MEM). In various implementations, other types of instructions are included in the wavefronts, and each of these instruction types are further distinguished by being vector types or scalar types.

The control circuitry monitors the age of the oldest memory access instruction of each of the 16 buffers of instruction buffers 410. In the illustrated implementation, the buffer “Wave0_IB” of instruction buffers 410 for wavefront 0 has a memory access instruction (MEM) in entry 0, which is the oldest instruction for the corresponding wavefront 0. The buffer “Wave1_IB” of instruction buffers 410 for wavefront 1 has a memory access instruction (MEM) in entry 1, which is the oldest memory access instruction for the corresponding wavefront 15. The buffer “Wave15_IB” of instruction buffers 410 for wavefront 15 has a memory access instruction (MEM) in entry 2, which is the oldest memory access instruction for the corresponding wavefront 15. In some implementations, the control circuitry asserts a bit of a bit position in flag buffers 420 corresponding to entries of instruction buffers 410 that store a memory access instruction. In such implementations, the control circuitry negates a bit of a bit position in flag buffers 420 corresponding to entries of instruction buffers 410 that do not store a memory access instruction. In other implementations, the control circuitry asserts a bit of a bit position in flag buffers 420 corresponding to entries of instruction buffers 410 that store the oldest memory access instruction for a wavefront. In such implementations, the control circuitry negates a bit of a bit position in flag buffers 420 corresponding to entries of instruction buffers 410 that do not store the oldest memory access instruction. In an implementation, a Boolean ‘1’ is used as the asserted value and a Boolean ‘0’ is used as the negated value. In other implementations, a Boolean ‘0’ is used as the asserted value and a Boolean ‘1’ is used as the negated value.

When it is time to issue instructions from instruction buffers 410 to the vector processing circuits, the control circuitry generates priority levels for the multiple wavefronts based on the ages of the oldest memory access instruction of each of the wavefronts. It is possible that two or more wavefronts have the same priority level due to having the same age for the corresponding oldest memory access instructions. In various implementations, the higher the age of the oldest memory access instruction, the higher the priority level for the corresponding wavefront. As described earlier, in an implementation, instruction buffers 410 and flag buffers 420 are first-in-first-out (FIFO) buffers where “data0” is the oldest entry and “data15” is the youngest entry. In such an implementation, the lower the position (the lower the entry number) of the memory access instruction in a corresponding instruction buffer, the older is the memory access instruction corresponding to the entry and the higher the priority level for the corresponding wavefront. The position is indicated by the actual entry in the instruction buffers 410 or the flag buffers 420. Alternatively, the position is indicated by updated pointer values indicating the first allocated entry (oldest entry) and the last allocated entry (youngest entry) of instruction buffers 410 and flag buffers 420. In other implementations, the ages of the oldest memory access instructions stored in the instruction buffers are indicated by an age field in the entries of the instruction buffers. Other indications of the ages of the oldest memory access instructions stored in the instruction buffers are possible and contemplated in other implementations.

Using flag buffers 420, the wavefront 0 corresponding to buffer “Wave0_IB” of instruction buffers 410 has a higher priority level than at least the wavefront 1 and the wavefront 15 corresponding to buffers “Wave1_IB” and “Wave15_IB” of instruction buffers 410. Using flag buffers 420, the wavefront 1 corresponding to buffer “Wave1_IB” has a higher priority level than at least the wavefront 15 corresponding to buffer “Wave15_IB” of instruction buffers 410. The indication of the priority level can use one of a variety of formats such as a multi-bit Boolean value, a numerical value, an indication of a range, and so forth. The compute circuit issues instructions to the multiple vector processing circuits based at least in part on the priority levels generated based on the content stored in flag buffers 420. It is noted that the type of instruction issued for a wavefront can be a different instruction type from a memory access instruction. The oldest instruction is issued. In an implementation different from the illustrated implementation, the wavefront 15 corresponding to buffer “Wave15_IB” of instruction buffers 410 has a higher priority level of the wavefronts 0 through 15 with an oldest memory access instruction in entry 2 of instruction buffers 410 and flag buffers 420. The instruction of wavefront 15 stored in entry 0 corresponding to buffer “Wave15_IB” of instruction buffers 410 can be an arithmetic instruction, a conditional control flow instruction (branch instruction), or other type of instruction different from the memory access instruction type. This instruction in entry 0 of instruction buffers 410 for wavefront 15 is issued based at least in part on the oldest memory access instruction in entry 2 of instruction buffers 410.

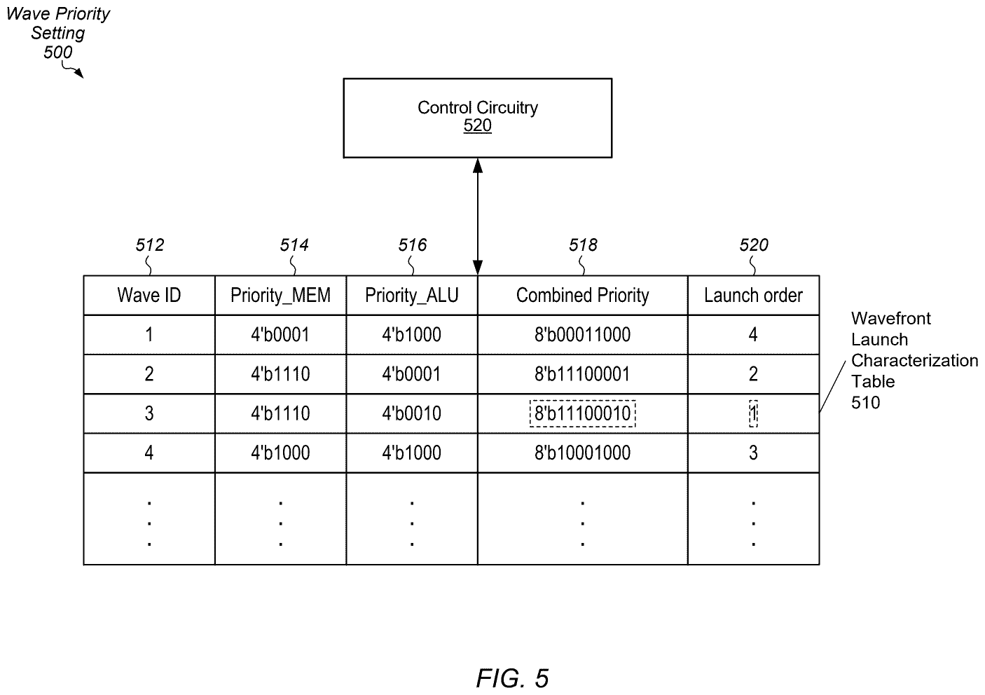

Referring to FIG. 5, a generalized diagram is shown of wave priority setting 500 for efficiently scheduling instructions of different types for a parallel data processing circuit. In the illustrated implementation, control circuitry 520 accesses the wavefront launch characterization table 510 (or table 510). Control circuitry 520 updates the priority levels used to generate indications of which wavefronts have instructions issued in a particular clock cycle. Table 510 is implemented with one of flip-flop circuits, one of a variety of types of a random-access memory (RAM), a content addressable memory (CAM), or other. As shown, table 510 stores information in multiple entries, and each of these entries includes the fields 512-520. Although particular information is shown as being stored in the fields 512-520, and in a particular contiguous order, in other implementations, a different order is used and a different number and type of information is stored.

Field 512 stores a unique identifier (ID) of a wavefront being executed in a compute circuit. Field 514 stores the priority level of a corresponding wavefront based on ages of the oldest memory access instructions of wavefronts. In various implementations, wave priority setting 400 (of FIG. 4) is used to generate the priority levels stored in field 514 and the description of wave priority setting 400 provides further details. Field 516 stores the priority level based on a count of processed (issued, executed, completed or retired) arithmetic instructions. The description of wave priority setting 300 (of FIG. 3) provides further details. Field 518 stores a value based on a combination of the values stored in fields 514 and 516. In some implementations, for each of the wavefronts, control circuitry 520 concatenates the corresponding values stored in fields 514 and 516. In an implementation, control circuitry 520 has the value stored in field 514 occupy the most significant bits of the concatenated value. In other implementations, control circuitry 520 has the value stored in field 516 occupy the most significant bits of the concatenated value. In yet other implementations, for each of the wavefronts, control circuitry 520 generates a weighted sum using the corresponding values stored in fields 514 and 516. Using other types of combinations for generating the combined priority stored in field 518 is possible and contemplated. Field 520 stores an indication of a launch order for a corresponding wavefront based on the value stored in field 518 and comparisons by control circuitry 520 with other values stored in field 518 for other wavefronts.

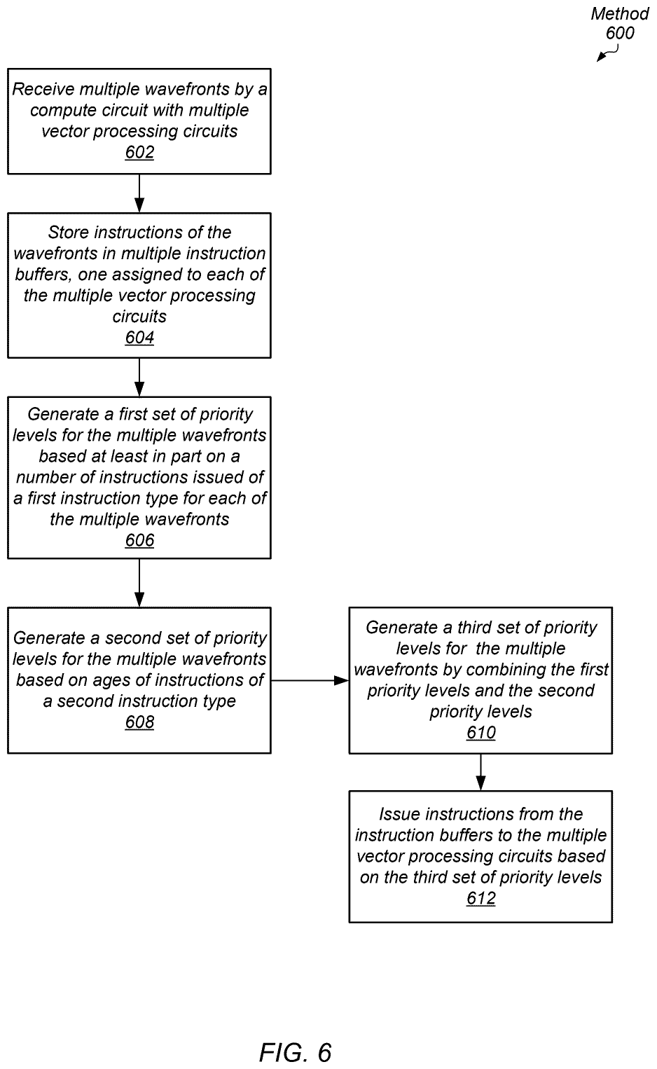

Referring to FIG. 6, a generalized diagram is shown of a method 600 for efficiently scheduling instructions of different types for a parallel data processing circuit. For purposes of discussion, the steps in this implementation (as well as in FIGS. 7-8) are shown in sequential order. However, in other implementations some steps occur in a different order than shown, some steps are performed concurrently, some steps are combined with other steps, and some steps are absent.

A computing system includes at least a first processing circuit and a second processing circuit. In some implementations, the first processing circuit is a host processing circuit that generates commands for the second processing circuit by translating instructions of a parallel data application. The second processing circuit is a parallel data processing circuit that includes multiple compute circuits, each with multiple vector processing circuits (or SIMD circuits). The first processing circuit stores the commands in a ring buffer in system memory. The second processing circuit reads the commands from the ring buffer in the system memory. A compute circuit with multiple vector processing circuits (or SIMD circuits) receives multiple wavefronts (block 602).

The compute circuit stores instructions of the wavefronts in multiple instruction buffers, one assigned to each of the multiple vector processing circuits (block 604). The compute circuit generates a first set of priority levels for the multiple wavefronts based at least in part on a number of instructions issued of a first instruction type for each of the multiple wavefronts (block 606). In some implementations, the first instruction type is a vector arithmetic type of instruction. The first set of priority levels includes balancing execution of instructions of the first instruction type across the multiple wavefronts. For example, the first set of priority levels is based at least in part on a count of issued vector arithmetic instructions for each wavefront. The wavefront of the multiple wavefronts that reaches a count threshold has its priority level of the first set of priority levels set to a minimum level. Wavefronts that are younger than the wavefront that reached the count threshold have their priority levels of the first set of priority levels increased. Further details are provided in the description of at least the wave priority setting 300 (of FIG. 3) and the method 700 (of FIG. 7).

The compute circuit generates a second set of priority levels for the multiple wavefronts based on ages of instructions of a second instruction type (block 608). In an implementation, the second instruction type is a vector memory access type of instruction. In some implementations, the wavefronts that have the oldest vector memory access instructions have higher priority levels of the second set of priority levels than priority levels of wavefronts with younger vector memory access instructions. In an implementation, the instruction buffers use a first-in-first-out (FIFO) data storage arrangement such that the position of an instruction in the instruction buffer indicates the age of the instruction. The position is indicated by the actual entry in the instruction buffer or the position is indicated by updated pointer values indicating the first allocated entry (oldest entry) and the last allocated entry (youngest entry). Further details are provided in the description of at least the wave priority setting 400 (of FIG. 4) and the method 800 (of FIG. 8). The compute circuit generates a third set of priority levels for the multiple wavefronts by combining the first priority levels and the second priority levels (block 610). In some implementations, for each of the wavefronts, the compute circuit concatenates the corresponding values of the first set of priority levels and the second set of priority levels. In an implementation, the compute circuit has the corresponding value of the second set of priority levels occupy the most significant bits of the concatenated value. In other implementations, the compute circuit has the corresponding value of the first set of priority levels occupy the most significant bits of the concatenated value.

In yet other implementations, for each of the wavefronts, the compute circuit generates a weighted sum using the corresponding values of the first set of priority levels and the second set of priority levels. Using other types of combinations for generating the third set of priority levels is possible and contemplated. The compute circuit issues instructions from the instruction buffers to the multiple vector processing circuits based on the third priority levels (block 612).

Turning now to FIG. 7, a generalized diagram is shown of a method 700 for efficiently scheduling instructions of different types for a parallel data processing circuit. A compute circuit with multiple vector processing circuits receives wavefronts (block 702). The compute circuit stores instructions of the wavefronts in multiple instruction buffers, one assigned to each of the multiple vector processing circuits (block 704). The compute circuit monitors an age of each of the multiple wavefronts assigned to the multiple vector processing circuits (block 706). The compute circuit counts, for each of the multiple vector processing circuits assigned to the multiple wavefronts, a number of arithmetic instructions that have been processed (block 708). In some implementations, the compute circuit counts a particular vector arithmetic instruction. In another implementation, the compute circuit counts each type of vector arithmetic instruction. In other implementations, the compute circuit counts each type or a particular type of scalar arithmetic instruction.

If any count of the multiple counts for the vector processing circuits does not exceed a count threshold (“no” branch of the conditional block 710), then compute circuit generates, based on ages of the multiple wavefronts, priority levels for the multiple wavefronts used for instruction issue (block 720). In an implementation, the compute circuit generates priority levels for the wavefronts that have an inverse relationship with the ages of the wavefronts. A youngest wavefront has the lowest priority, whereas the oldest wavefront has the highest priority. Afterward, the compute circuit issues instructions to the multiple vector processing circuits based at least in part on the priority levels (block 722).

In some implementations, the count threshold is stored in a programmable configuration register. If a count of multiple counts for the vector processing circuits exceeds the count threshold (“yes” branch of the conditional block 710), then for wavefronts with ages younger than an age of the wavefront corresponding to the count exceeding the count threshold, the compute circuit updates the ages to older ages while maintaining relative ages between one another (block 712). For wavefronts with ages older than an age of the wavefront corresponding to the count exceeding the count threshold, the compute circuit maintains the ages (block 714).

For the wavefront corresponding to the count exceeding the count threshold, the compute circuit resets its count (block 716). For the wavefront corresponding to the count exceeding the count threshold, the compute circuit sets its age to a youngest age (block 718). The compute circuit generates, based on ages of the multiple wavefronts, priority levels for the multiple wavefronts used for instruction issue (block 720). In an implementation, the compute circuit generates priority levels for the wavefronts that have an inverse relationship with the ages of the wavefronts. A youngest wavefront has the lowest priority, whereas the oldest wavefront has the highest priority.

Referring to FIG. 8, a generalized diagram is shown of a method 800 for efficiently scheduling instructions of different types for a parallel data processing circuit. A compute circuit with multiple vector processing circuits receives wavefronts (block 802). The compute circuit stores instructions of the wavefronts in multiple instruction buffers, one assigned to each of the multiple vector processing circuits (block 804). The compute circuit monitors an age of an oldest memory access instruction of each of the instruction buffers (block 806). In an implementation, the instruction buffers include an instruction buffer for each of the wavefronts, and each instruction buffer is a first-in-first-out (FIFO) buffer. In such an implementation, the lower the position (the lower the entry number) of the memory access instruction in a corresponding instruction buffer, the older is the memory access instruction corresponding to the entry and the higher the priority level for the corresponding wavefront. The position is indicated by the actual entry in the instruction buffers. Alternatively, the position is indicated by updated pointer values indicating the first allocated entry (oldest entry) and the last allocated entry (youngest entry) of instruction buffers. In other implementations, the ages of the oldest memory access instructions stored in the instruction buffers are indicated by an age field in the entries of the instruction buffers. Other indications of the ages of the oldest memory access instructions stored in the instruction buffers are possible and contemplated in other implementations. If it is not time to issue instructions from instruction buffers to the vector processing circuits (“no” branch of the conditional block 808), then control flow of method 800 returns to block 806 where the compute circuit monitors the age of the oldest memory access instruction of each of the instruction buffers.

If it is time to issue instructions from instruction buffers to the vector processing circuits (“yes” branch of the conditional block 808), then the compute circuit generates priority levels for the multiple wavefronts used for instruction issue based on ages of the oldest memory access instruction of each of the instruction buffers (block 810). It is possible that two or more wavefronts have the same priority level due to having the same age of the oldest memory access instruction. The compute circuit issues instructions to the multiple vector processing circuits based at least in part on the priority levels (block 812). The compute circuit updates the ages of the oldest memory access instructions of the multiple vector processing circuits as instructions are issued (block 814). Afterward, control flow of method 800 returns to block 806 where the compute circuit monitors the age of the oldest memory access instruction of each of the instruction buffers.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is

1. An apparatus comprising:
a plurality of vector processing circuits, each configured to execute instructions of a wavefront;
a plurality of instruction buffers, each comprising circuitry configured to store instructions of a corresponding one of a plurality of wavefronts; and
circuitry configured to:
generate a first plurality of priority levels for the plurality of wavefronts based at least in part on balancing execution of instructions of a first instruction type across the plurality of wavefronts; and
issue instructions from the plurality of instruction buffers to the plurality of vector processing circuits based on the first plurality of priority levels.

2. The apparatus as recited in claim 1, wherein the circuitry is configured to generate the first plurality of priority levels based at least in further part on satisfying urgency of execution of instructions of a second instruction type across the plurality of wavefronts.

3. The apparatus as recited in claim 2, wherein to balance execution of instructions of the first instruction type across the plurality of wavefronts, the circuitry is configured to generate a second plurality of priority levels for the plurality of wavefronts based on a number of instructions issued of the first instruction type for each of the plurality of wavefronts.

4. The apparatus as recited in claim 3, wherein the first instruction type is a vector arithmetic type of instruction.

5. The apparatus as recited in claim 3, wherein to satisfy urgency of execution of instructions of the second instruction type across the plurality of wavefronts, the circuitry is configured to generate a third plurality of priority levels for the plurality of wavefronts based on ages of instructions of the second instruction type for each of the plurality of wavefronts.

6. The apparatus as recited in claim 5, wherein the second instruction type is a vector memory access type of instruction.

7. The apparatus as recited in claim 5, wherein to generate the first plurality of priority levels for the plurality of wavefronts, the circuitry is configured to combine the second priority levels and the third priority levels.

8. A method, comprising:
executing instructions of a wavefront by each of a plurality of vector processing circuits;
storing instructions of a corresponding one of a plurality of wavefronts by each of a plurality of instruction buffers;
generating, by circuitry, a first plurality of priority levels for the plurality of wavefronts based at least in part on balancing execution of instructions of a first instruction type across the plurality of wavefronts; and
issuing instructions, by the circuitry, from the plurality of instruction buffers to the plurality of vector processing circuits based on the first plurality of priority levels.

9. The method as recited in claim 8, further comprising generating, by the circuitry, the first plurality of priority levels based at least in further part on satisfying urgency of execution of instructions of a second instruction type across the plurality of wavefronts.

10. The method as recited in claim 9, wherein to balance execution of instructions of the first instruction type across the plurality of wavefronts, the method further comprises generating, by the circuitry, a second plurality of priority levels for the plurality of wavefronts based on a number of instructions issued of the first instruction type for each of the plurality of wavefronts.

11. The method as recited in claim 10, wherein the first instruction type is a vector arithmetic type of instruction.

12. The method as recited in claim 10, wherein to satisfy urgency of execution of instructions of the second instruction type across the plurality of wavefronts, the method further comprises generating, by the circuitry, a third plurality of priority levels for the plurality of wavefronts based on ages of instructions of the second instruction type for each of the plurality of wavefronts.

13. The method as recited in claim 12, wherein the second instruction type is a vector memory access type of instruction.

14. The method as recited in claim 12, wherein to generate the first plurality of priority levels for the plurality of wavefronts, the method further comprises combining, by the circuitry, the second priority levels and the third priority levels.

15. A computing system comprising:
a memory; and
a processing circuit comprising:
a plurality of compute circuits, each comprising:
a plurality of vector processing circuits, each configured to execute instructions of a wavefront stored in the memory;
a plurality of instruction buffers, each comprising circuitry configured to store instructions of a corresponding one of a plurality of wavefronts; and
circuitry configured to:
generate a first plurality of priority levels for the plurality of wavefronts based at least in part on balancing execution of instructions of a first instruction type across the plurality of wavefronts; and
issue instructions from the plurality of instruction buffers to the plurality of vector processing circuits based on the first plurality of priority levels.

16. The computing system as recited in claim 15, wherein the circuitry is configured to generate the first plurality of priority levels based at least in further part on satisfying urgency of execution of instructions of a second instruction type across the plurality of wavefronts.

17. The computing system as recited in claim 16, wherein to balance execution of instructions of the first instruction type across the plurality of wavefronts, the circuitry is configured to generate a second plurality of priority levels for the plurality of wavefronts based on a number of instructions issued of the first instruction type for each of the plurality of wavefronts.

18. The computing system as recited in claim 17, wherein the first instruction type is a vector arithmetic type of instruction.

19. The computing system as recited in claim 17, wherein to satisfy urgency of execution of instructions of the second instruction type across the plurality of wavefronts, the circuitry is configured to generate a third plurality of priority levels for the plurality of wavefronts based on ages of instructions of the second instruction type for each of the plurality of wavefronts.

20. The computing system as recited in claim 19, wherein the second instruction type is a vector memory access type of instruction.
